(19) United States
(12) Patent Application Publication
(10) Pub. No.: US 2011/0113038 A1
(43) Pub. Date: May 12, 2011

(54) SEARCH TERM SECURITY

(75) Inventors: Elmer K. Corbin, Hopewell Junction, NY (US); Richard Ferri, Ulster Park, NY (US); Moon J. Kim, Wappingers Falls, NY (US); Lev Kozakov, Stamford, CT (US)

(73) Assignee: International Business Machines Corporation, Armonk, NY (US)

(21) Appl. No.: 12/617,160

(22) Filed: Nov. 12, 2009

(51) Int. Cl. G06F 17/30

(52) U.S. Cl. 707/748; 707/754; 707/E17.014; 707/E17.059

(57) ABSTRACT

As indicated above, the present invention transparently inserts search arguments/terms (referred to as noise) into a search string so that the search arguments themselves would not be clearly evident when a user is searching. The inserted noise terms are related to the underlying search terms. This would confuse a mining program and/or hacker looking for sensitive material (such as intellectual property). When the search results are returned, any “hits” resulting from noise will be removed transparently from the overall results. The insertion and removal under the present invention provides a more secure level of searching, yet is completely transparent to the end user. The inserted random search arguments are germane contextually to the search string.

### CROSS-REFERENCE TO RELATED APPLICATION

This application is related in some aspects to the commonly owned and co-pending application United States patent application entitled “Masking Search Queries”, having a serial number (to be provided), and attorney docket number of END920090080US1, filed on (to be provided).

### FIELD OF THE INVENTION

The present invention generally relates to web security. Specifically, the present invention provides a way to protect search terms from mining, discovery, etc.

### BACKGROUND OF THE INVENTION

There is a security problem with the way web searches are done today. Search arguments sent to a large search site are collected and stored in aggregate for later mining. While this type of storing and data mining might not be of interest to a private user researching the purchase of a new automobile, it creates a security risk to users working on new intellectual property. While working on new intellectual property, the search arguments themselves might provide enough information for a search company to reverse engineer the new intellectual property. These types of stored search strings by a search company could potentially constitute a breach of corporate security, which is not adequately addressed by working within a company intranet or company firewalls.

For example, when a person researches a patent application, the search arguments “reserve emergency battery power cell phone” themselves reveal information which may be proprietary. Instead of being protected by the corporate intranet, and the corporate firewall, the search arguments are sent to an outside search Internet Search Provider (ISP) and are stored in its database in a way that could be mined for leading edge intellectual property. Additionally, specific networks can be monitored for intellectual property and later mined.

Inadvertent disclosure of search arguments can also create a potential security risk for many areas of proprietary projects for an organization. Exposing this information to an outside organization constitutes a security breach even if no explicit mining is done. Further, intelligent mining (e.g. when the search company detects searches from large corporate research firms) could narrow and focus the mining effort. Moreover, security breaches of companies owning large search engines, could also potentially expose the valuable search argument information.

### SUMMARY OF THE INVENTION

In general, the present invention transparently inserts search arguments/terms (referred to as noise) into a search string so that the search arguments themselves would not be clearly evident when a user is searching. The inserted “noise” terms are related to the underlying search terms. This would confuse a mining program and/or hacker looking for sensitive material (such as intellectual property). When the search results are returned, any “hits” resulting from noise will be removed transparently from the overall results. The insertion and removal under the present invention provides a more secure level of searching, yet is completely transparent to the end user. It is important to note that the inserted random search arguments are germane contextually to the search string.

A first aspect of the present invention provides a method for search term security, comprising: receiving a search string from a requester, the search string comprising a set of search terms; inserting a set of additional terms into the search string to yield a secure search string, the set of additional terms being related to a subject to which the set of search terms pertain; receiving a set of overall results from a search performed using the secure search string; and removing any hits from the set of overall results that resulted from the set of additional terms to yield a set of filtered results.

A second aspect of the present invention provides a data processing system for providing search term security, comprising: a memory medium comprising instructions; a bus coupled to the memory medium; and a processor coupled to the bus that when executing the instructions causes the data processing system to: receive a search string from a requester, the search string comprising a set of search terms; insert a set of additional terms into the search string to yield a secure search string, the set of additional terms being related to a subject to which the set of search terms pertain; receive a set of overall results from a search performed using the secure search string; and remove any hits from the set of overall results that resulted from the set of additional terms to yield a set of filtered results.

A third aspect of the present invention provides a computer readable medium containing a program product for providing search term security, the computer readable medium comprising instructions that cause a computer to: receive a search string from a requester, the search string comprising a set of search terms; insert a set of additional terms into the search string to yield a secure search string, the set of additional terms being related to a subject to which the set of search terms pertain; receive a set of overall results from a search performed using the secure search string; and remove any hits from the set of overall results that resulted from the set of additional terms to yield a set of filtered results.

A fourth aspect of the present invention provides a method for deploying a system for search term security, comprising: providing a computer infrastructure being operable to: receive a search string from a requester, the search string comprising a set of search terms; insert a set of additional terms into the search string to yield a secure search string, the set of additional terms being related to a subject to which the set of search terms pertain; receive a set of overall results from a search performed using the secure search string; and remove any hits from the set of overall results that resulted from the set of additional terms to yield a set of filtered results.

A fifth aspect of the present invention provides a system for search term security, comprising: a module for receiving a search string from a requester, the search string comprising a set of search terms; a module for inserting a set of additional terms into the search string to yield a secure search string, the set of additional terms being related to a subject to which the set of search terms pertain; a module for receiving a set of overall results from a search performed using the secure search string; and a module for removing any hits from the set of overall results that resulted from the set of additional terms to yield a set of filtered results.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a method flow diagram for providing search term security according to an aspect of the present invention.

FIG. 2 shows an architectural flow diagram for providing search term security according to an aspect of the present invention.

FIG. 3 shows a more specific computerized implementation for providing search term security according an aspect to the present invention.

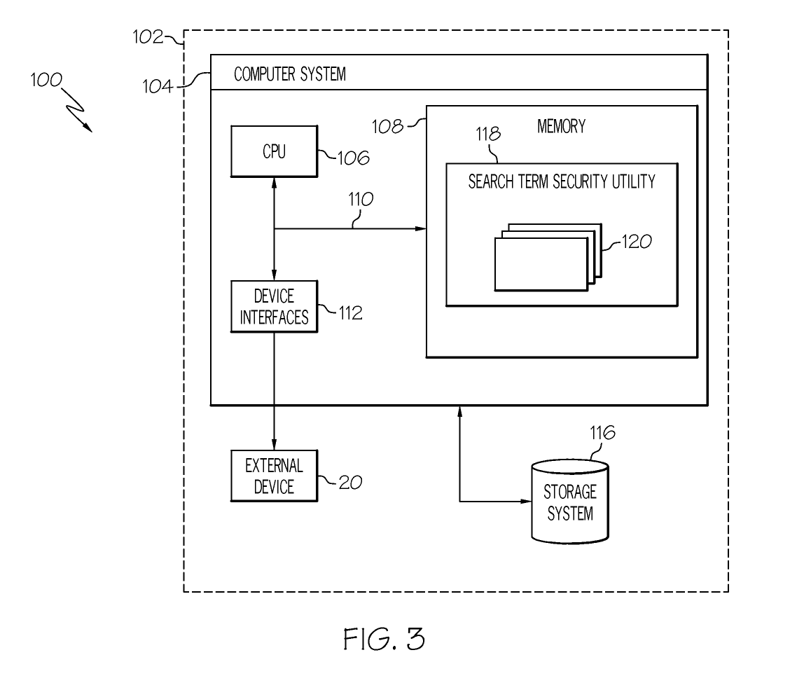

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As indicated above, the present invention transparently inserts search arguments/terms (referred to as noise) into a search string, so that the search arguments themselves would not be clearly evident when a user is searching. The insert noise terms are related to the underlying search terms. This would confuse a mining program and/or hacker looking for sensitive material (such as intellectual property). When the search results are returned, any “hits” resulting from noise will be removed transparently from the overall results. The insertion and removal under the present invention provides a more secure level of searching, yet is completely transparent to the end user. It is important to note that the inserted random search arguments are germane contextually to the search string. It should be understood that as used herein, the term “hit” is intended to refer to a result obtained from a search.

Under the present invention, a user formulates a search composed of a search string (a series of arguments) and enters them into to a search field (e.g., of a search engine). The teachings of the present invention can be implemented in conjunction with any type of search engine (e.g., Internet, Intranet, etc.). Once the search is submitted by the user, noise will be inserted into the search string. Specifically, keywords in the search string are isolated to determine to what subject (e.g., biology, information technology, civil engineering) the keywords relate. Based on the detected subject, a contextually relevant dictionary (a dictionary of engineering terms for example) is searched and a set (e.g., at least one) of terms related to the search terms are selected (e.g., randomly). For example, if researching a new car, interjecting search arguments related to mathematics would be easily detected. However, interjecting search arguments related to the search string (e.g., from a car mechanics handbook) would make detection much more difficult. In the case of information technology, random search words could be interjected from an information technology dictionary of terms, for example.

The set of terms is then inserted into the search, transparent to the user, resulting in a “noisy” search string. The inserted set of terms should be selected in a way that enables clear separation of the “noise” terms from the actual search terms. This can be achieved by using criteria such as lexical proximity and frequency of occurrence. For clarity, the term(s) inserted into the search string may be referred to herein as security terms, inserted term(s), inserted noise, or anything of the like.

The composed search string is searched and relevant pages identified and returned to the web browser. Then, a second level search (i.e., of the results) is performed on the set of inserted terms/noise. Based on the search, any search “hits” that resulted from the inserted noise will be removed from the results presented/displayed to the user. Similar to the insertion of noise, the second level search and/or removal of noise-based (e.g., false) hits can be done transparent to the user.

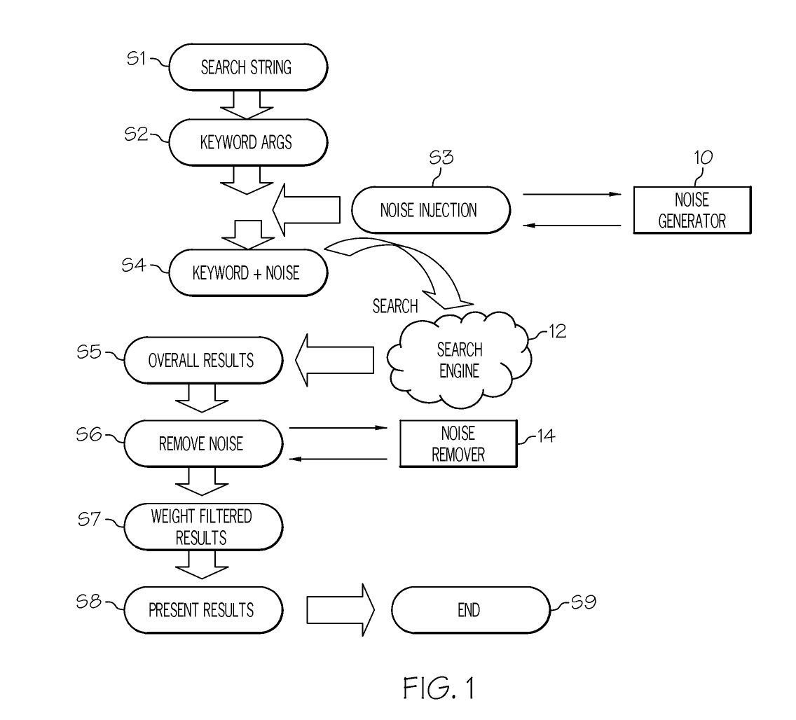

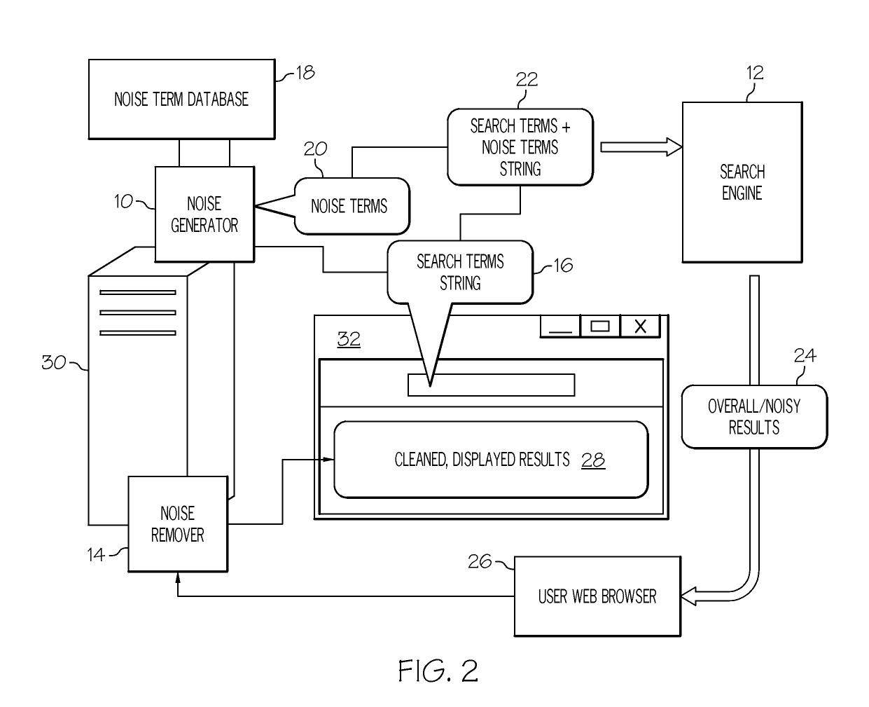

Referring to FIGS. 1 and 2, the sequence of events for the present invention will be described in greater detail. In step S1, the requester (e.g., a user, a computer, etc.) inputs a Web search string 16 (e.g., via search engine 12. In step S2, the system isolates keywords in the input search string. In step S3, noise 20 is inserted into the search based on keywords from noise generator 10. As indicated above, noise 20 comprises a set of terms that: are related to the search string input by the requester; selected from a reference (e.g., dictionary, noise term database 18, etc.) or the like; and are inserted into the input search string transparent to the requester. In step S4, it can be seen that the input search string now equals Keywords+Noise. In step S5, the search is performed via search engine 12. In step S5, overall/noisy results (hereinafter overall results 24) are returned (e.g., to user web browser 26). In step S6, the overall results 24 are “cleaned by” removing hits resulting from the inserted noise via noise remover 14. As mentioned above, this is typically accomplished via a second level search (on the results returned from search engine 12) that is based on inserted noise. Moreover, the second level search and removal of noise-based hits are typically performed transparent to the requester. In step S7, the cleaned results 28 can be optionally weighted (e.g., using any weighting algorithm). In step S8 cleaned results 28 (and optionally weighted results) are presented to the requestor, and in step S9, the process ends.

It is important to note that using this method, the clean search string (the search string minus noise) is never displayed outside the user's web browser; the noisy string (with random relevant search words inserted) would be the only string received by the search engine, and would be much more difficult to mine for intellectual property. In addition, a noise generator can include and/or it can consult with a reference such as a domain specific glossary for finding “noise” terms and select the terms that are within the domain yet have minimal lexical proximity to the actual search terms and low enough frequency of occurrence. The generator may use a “noise” glossary from a domain, which is an “adjacent” domain to the actual search domain (for instance, if the original domain is computer science, the “noise” domain can be mathematics).

The present invention can be provided as a browser plug-in (e.g. Firefox add-on). In this embodiment, major search providers can be registered by the browser. When a user comes to a registered search page, the plug-in asks to choose “regular search” or “confidential search” mode. In the confidential search mode, the plug-in
(a) analyzes the search query,
(b) identifies the domain specific glossary (such glossaries can be downloaded from the web or generated from the results of predefined search queries),
(c) selects the “noise” terms that should be added to the original query,
(d) submits the compound query to the search engine,
(e) stores the compound search results in the local file system/memory,
(f) generates and submits the “noise cleaning” queries to isolate and drop the results related to the “noise” terms, and
(g) displays the clean results to the user.

Note 1: the plug-in can cache some frequent queries in order to bring fast results first, and then go to the full cycle if a user wants to refresh the results.

Note 2: the plug-in can use interactive learning techniques to improve the process of selecting “noise” terms—a user may rate the selected terms based on the ability to isolate the “noise” search results from the actual search results.

In another embodiment, the present invention can be implemented in an intranet environment. In this case, the function of “confidential public search” can be implemented by a special intermediate server (Intranet site) that can be accessed from the corporate Intranet. The basic steps are similar. The browser-based approach mentioned above with possible distinctions (e.g., domain-specific glossaries and algorithm of selecting “noise” terms can be improved based on the feedback provided by multiple user).

### II. Computerized Implementation

Referring now to FIG. 2, a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

As shown, computer system 104 includes a processing unit 106, a memory 108, a bus 110, and device interfaces 112. Further, computer system 104 is shown communicating with one or more external devices 20 that communicate with bus via device interfaces. In general, processing unit 106 executes computer program code, such as search term security utility 118, which is stored in memory 108 and/or storage system 116. While executing computer program code, processing unit 106 can read and/or write data to/from memory 108, storage system 116, and/or device interfaces 112. Bus 110 provides a communication link between each of the components in computer system 104. Although not shown, computer system 104 could also include I/O interfaces that communicate with: one or more external devices such as a kiosk, a checkout station, a keyboard, a pointing device, a display, etc.); one or more devices that enable a user to interact with computer system 104; and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various processes of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more location (e.g., on a client and server). Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 2 can be included in computer system 104.

Storage system/log 116 can be any type of system capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is search term security utility 118, which includes a set of modules 120. Set of modules 120 generally provide all functions of the present invention as described herein. Along these lines, set of modules 120 should be understood to include components such as noise generator 10 and noise remover 14. Specifically (among other things), set of modules 120 is configured to: receive a search string from a requester, the search string comprising a set of search terms; insert a set of additional terms into the search string to yield a secure search string; receive a set of overall results from a search performed using the secure search string; remove any hits from the set of overall results that resulted from the set of additional terms to yield a set of filtered results; isolate at least a subset of the set of search terms; consult at least one reference related to the subject to identify the set of additional terms based on the isolating; weight the set of filtered results; and present the results to the requestor.

While shown and described herein as a search term security solution, it is understood that the invention further provides various alternative embodiments. For example, in one embodiment, the invention provides a computer-readable/useable medium that includes computer program code to enable a computer infrastructure to provide search term security. To this extent, the computer-readable/useable medium includes program code that implements each of the various processes of the invention. It is understood that the terms computer-readable medium or computer-useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 2) and/or storage system 116 (FIG. 2) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a method that performs the process of the invention on a subscription, advertising, and/or fee basis. That is, a service provider, such as a Solution Integrator, could offer to provide search term security. In this case, the service provider can create, maintain, support, etc., a computer infrastructure, such as computer infrastructure 102 (FIG. 2) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for providing search term security. In this case, a computer infrastructure, such as computer infrastructure 102 (FIG. 2), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 2), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for providing search term security, comprising:
receiving a search string from a requester, the search string comprising a set of search terms;
inserting a set of additional terms into the search string to yield a secure search string, the set of additional terms being related to a subject to which the set of search terms pertain;
receiving a set of overall results from a search performed using the secure search string; and
removing any hits from the set of overall results that resulted from the set of additional terms to yield a set of filtered results.

2. The method of claim 1, further comprising identifying the set of additional terms for insertion, the identifying comprising:
isolating at least a subset of the set of search terms; and
consulting at least one reference related to a subject to which the subset of search terms pertain so as to identify the set of additional terms based on the isolating.

3. The method of claim 1, further comprising presenting the set of filtered result to the requester.

4. The method of claim 3, the requester being at least one of the following: a user or a computer.

5. The method of claim 1, further comprising:
weighting the set of filtered results; and
presenting the set of filter results after the weighting.

6. The method of claim 1, the set of additional terms being inserted into the search string as noise.

7. A data processing system for providing search term security, comprising:
a memory medium comprising instructions;
a bus coupled to the memory medium; and
a processor coupled to the bus that when executing the instructions causes the data processing system to:
receive a search string from a requester, the search string comprising a set of search terms,
insert a set of additional terms into the search string to yield a secure search string, the set of additional terms being related to a subject to which the set of search terms pertain,
receive a set of overall results from a search performed using the secure search string, and
remove any hits from the set of overall results that resulted from the set of additional terms to yield a set of filtered results.

8. The data processing of claim 7, the processor further causing the data processing system to:
isolate at least a subset of the set of search terms; and
consult at least one reference related to a subject to which the subset of search terms pertain so as to identify the set of additional terms based on the isolating.

9. The data processing of claim 7, the processor further causing the data processing system to present the set of filtered results to the requester.

10. The data processing of claim 9, the requester being at least one of the following: a user or a computer.

11. The data processing of claim 7, the processor further causing the data processing system to:
weight the set of filtered results; and
present the set of filter results after the weighting.

12. The data processing of claim 7, the set of additional terms being inserted into the search string as noise.

13. A computer readable medium containing a program product for providing search term security, the computer readable medium comprising instructions that cause a computer to:
receive a search string from a requester, the search string comprising a set of search terms;
insert a set of additional terms into the search string to yield a secure search string, the set of additional terms being related to a subject to which the set of search terms pertain;
receive a set of overall results from a search performed using the secure search string; and
remove any hits from the set of overall results that resulted from the set of additional terms to yield a set of filtered results.

14. The computer readable medium containing a program product of claim 13, the computer readable medium further comprising instructions that cause the computer to:
isolate at least a subset of the set of search terms; and
consult at least one reference related to a subject to which the subset of search terms pertain, so as to identify the set of additional terms based on the isolating.

15. The computer readable medium containing a program product of claim 13, the computer readable medium further comprising instructions that cause the computer to present the set of filtered result to the requester.

16. The computer readable medium containing a program product of claim 15, the requester being at least one of the following: a user or a computer.

17. The computer readable medium containing a program product of claim 13, the computer readable medium further comprising instructions that cause the computer to:
weight the set of filtered results; and
present the set of filter results after the weighting.

18. The computer readable medium containing a program product of claim 13, the set of additional terms being inserted into the search string as noise.

19. A method for deploying a system for providing search term security, comprising:
providing a computer infrastructure being operable to:
receive a search string from a requester, the search string comprising a set of search terms;
insert a set of additional terms into the search string to yield a secure search string, the set of additional terms being related to a subject to which the set of search terms pertain;
receive a set of overall results from a search performed using the secure search string; and
remove any hits from the set of overall results that resulted from the set of additional terms to yield a set of filtered results.

20. The method of claim 19, the computer infrastructure being further operable to:
isolate at least a subset of the set of search terms; and
consult at least one reference related to a subject to which the subset of search terms pertain, so as to identify the set of additional terms based on the isolating.
